(19) United States
(12) Patent Application Publication
(10) Pub. No.: US 2018/0012508 A1
(43) Pub. Date: Jan. 11, 2018

(54) INTERACTIVE GAME PLATFORM FOR ENABLING MENTAL PERFORMANCE ENHANCEMENT

(71) Applicant: FUNCTIONAL INTERACTIVE TIMING SYSTEM LTD., Petach Tikva (IL)

(72) Inventor: Adi SULKIN, Tel Aviv (IL)

(21) Appl. No.: 15/204,831

(22) Filed: Jul. 7, 2016

(51) Int. Cl. G09B 19/00

(52) U.S. Cl. CPC G09B 19/003

(57) ABSTRACT

There is provided, in accordance with an embodiment of the present invention, an apparatus, system, and method to provide enhanced mental performance using games, by proving rhythm based and/or sensory-motor challenges. In one embodiment a rhythm-training platform is provided that includes a user computing device configured to provide rhythmic visual and audio based cues to challenge a user to respond to the cues; and a user rhythm-training device connectable to the user computer device, the rhythm-training device having input keys adapted to enable highly accurate measurement of the user's mechanical responses to the cues on the keys, and for receiving via a user interface input an indication of the user's response performance, wherein the user computing device includes user level adapting code for controlling rhythm based audio challenges given to a user, to be personalized in accordance with the user's performance.

### FIELD OF THE INVENTION

The present invention relates in general to methods and devices useful in mental performance enhancement, and in particular to usage of games to help improve performance.

### BACKGROUND OF THE INVENTION

There has been an increasing prevalence of learning disabilities among children, that has been rising steadily in recent years. Many associated conditions have been observed to be steadily rising, such as attention deficit hyperactivity disorder (ADHD), concentration deficit disorder (CDD), Tourette syndrome, academic skills disorders, oppositional defiant disorder (ODD) and conduct disorder (CD), antisocial personality disorder, vigilance, difficulties staying awake, mood disorders (especially bipolar disorder and major depressive disorder), anxiety disorders, obsessive-compulsive disorder (OCD), substance use disorders, restless legs syndrome, sleep disorders and more. Additionally, the impact of the increase in attention and related disorders has resulted in Significant academic difficulties. Under developed social skills, Strained familial relationships, and Slow career progression.

Many studies have shown a connection between cognitive performance and the ability of a person to timely respond to auditory and or visual stimulation, thereby to perform motorically, especially with motor timing, and as such, cognitive performance has been shown to be enhanced using sensory training, to achieve significant benefits in improvement in attention, perception, memory, speech and language. Such studies have helped promote the use of sensory motor based training games to help users enhance mental performance.

### SUMMARY OF THE INVENTION

There is provided, in accordance with an embodiment of the present invention, an apparatus, system, and method to provide enhanced mental performance using neuro-motor, rhythmic games etc.

According to some embodiments, a sensory motor method for training a cognitive skill is provided, that includes: providing, via a user computing device user interface display, a game with a visual-timing challenge where a graphic view reflects a challenge that may be connected to an audio rhythm; receiving via a rhythm-training device the user's mechanical responses to the visual-timing challenge; processing the user's mechanical responses to determine response accuracy; providing, via the user interface, an indicator reflecting the user performance; and providing additional visual-time challenges to push the user to improve performance when engaging the game.

According to some embodiments, a rhythm-training platform is provided, comprising: a user computing device configured to provide graphic and rhythm based cues to challenge a user to respond to the cues; and a user rhythm-training device connectable to the user computer device, the rhythm-training device having input keys capable to enable highly accurate measurement of the user's responses to the cues on the keys, and for receiving via a user interface input an indication of the user's response performance, wherein the user computing device includes user level adapting code for controlling rhythm based audio challenges given to a user, to be personalized in accordance with the user's performance.

According to some embodiments, a machine readable medium is herein provided, containing instructions that, when executed by a computing device, cause the computing device to perform a mental performance training method, the method comprising: providing graphic and rhythm based reference cues, for example visual and/or auditory cues, to challenge a user to respond to the cues, by the computing device; recording user responses to the cues, as entered by the user on a rhythm-training device connected to the computing device, wherein the rhythm-training device has one or more input keys capable to enable highly accurate measurement of the user's responses to the cues in the range of 0.1-2 milliseconds (ms), and more typically, around 1 ms; processing the user responses to determine progress of user performance in response to challenges; and delivering to one or more machine readable medium users feedback on the progress of one or more users.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic system diagram depicting components of an interactive game platform for mental performance enhancement, according to some embodiments;

FIG. 2 is a schematic system diagram depicting the hardware and software elements of the interactive game platform, for facilitating mental performance enhancement using games or challenges, according to some embodiments;

FIG. 3 is a flow chart describing a process of delivering mental performance training using a rhythm training device, according to some embodiments;

FIG. 4 is a flow chart of an example of an implementation of a personalized mental enhancement game, according to some embodiments;

FIGS. 5A-5B are examples of a schematic graphic views of examples of a mental enhancement challenge game screen; according to some embodiments; and

FIGS. 6A-6B are examples of screenshots of examples of a mental enhancement challenge game screen, according to some embodiments.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

The term “mental performance” as used herein may refer to rhythm brain fitness, learning capacity, cognitive performance or skills, concentration, attention, coordination, working memory, motor timing skills, motor inhibition, time perception, responsiveness, impulsiveness, attention sustenance etc. The term “computing system” refers to PC's, laptops, network computers, tablets, smartphones, consoles, or other computing devices that may be used for gaining or training etc. As used hereinafter, the terms “visual timing challenge” or sensory-motor challenge” etc. may be used to refer to training or skills development games or challenges that integrate graphic-visual aspects and audio-rhythm aspects. As used hereinafter, the term “rhythm training device may be used to refer to apparatus's, devices, keypads, or other input devices connectable to computing devices, for enabling auditory and/or visual rhythm based gaming or training, or neuro-motor training, for example, using tapping to respond in synchronization to an audio signal. The term “machine readable medium” as used herein may refer to software, Applications, code, script, or algorithms containing instructions executable by a computing device, to cause the computing device to perform a mental performance training methods, as described herein. The term “game” may be used to refer to challenges, simulations, matches, contests, tournaments, playoffs, or other engaging interfaces oriented to challenge sensory-motor and rhythmic elements.

Non-limiting embodiments of the present invention include an apparatus/device, system, and method to provide enhanced mental performance using games, by providing personalized auditory based challenges, such as rhythmic stimulations, optionally together with visual stimulations.

According to some embodiments, a rhythm-training device connectable to a computer device can be used to accurately track user timing performance in relation to audio and/or visual rhythm based cues or challenges, using one or more fingers performing stationary and/or dynamic tapping or movements. In some embodiments, fixed rhythms or other audio cues may be used with highly accurate, or high resolution response measurement, to challenge a user to respond to the rhythm or cues, in accordance with a variety of beats per minute (BPM), patterns, finger and/or hand numbers, game varieties, levels of difficulty, etc.

In some embodiments, the rhythm-training device connectable to a computer device can be used to provide mental performance enhancement games or challenges, such as games designed to enhance concentration, attention, coordination, memory, motor timing skills, responsiveness etc. Further, the combination of game based challenges, coupled with a visual or graphic interface, may enable visual attention in addition to auditory attention, thereby enabling provision of engaging and entertaining training games. In further embodiments the device and system may enable user assessments or diagnostics, and/or treatment performance.

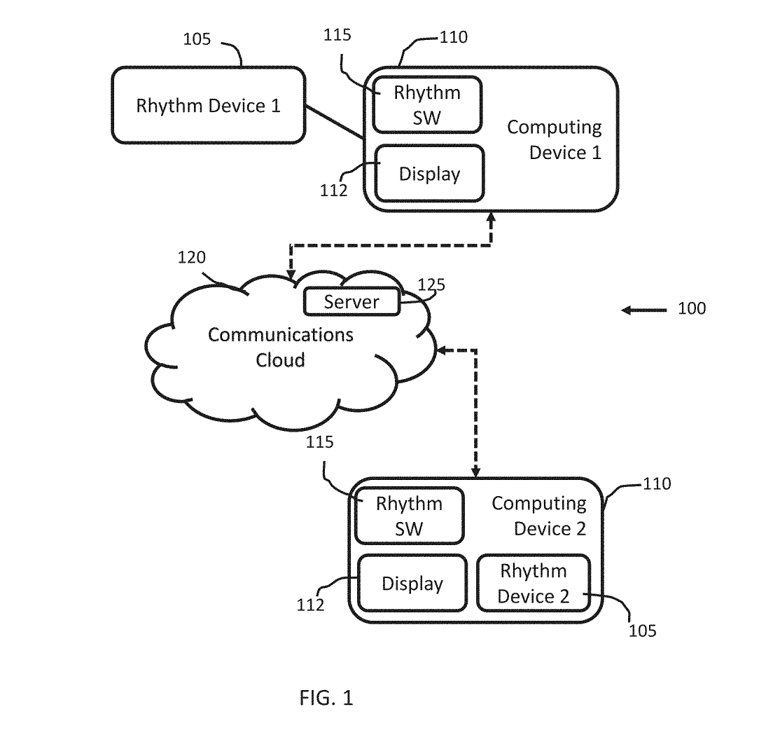

Reference is now made to FIG. 1, which is a schematic system diagram depicting an interactive game platform or system 100 for facilitating mental performance enhancement using games or challenges, according to some embodiments. As can be seen in the figure, system 100 includes a software sub-system 115, for example, a machine readable medium, application, program, script, instructions or code adapted to operate with a computer device 110, for example, a PC, tablet, smartphone, game console etc. System 100 further includes rhythm-training device 105, which is an external or internal hardware device designed to enable motor or mechanical response movements, such as finger tapping measurements, in a way that is time synchronized to computer device 110. Computing device(s) 110 are connected to a display component 112, typically a display panel or screen, or other display technology. Typically, computing device(s) 110 are connected to the Internet, and may be synchronized or otherwise communicatively connected to a communications cloud 120, generally supporting one or more game servers 125 and resources for storage of data, retrieving updates, billing, licensing and cooperating and/or synchronizing with other computer devices and/or rhythm-training devices connected to communications cloud 120.

In some embodiments, external or internal hardware device may include one or more mechanical keys, one or more touch response elements, one or more mechanical buttons, and/or one or more mechanical switches designed to enable motor or mechanical response recording.

In some embodiments, motor or mechanical responses may include single finger taps, multiple-finger taps, and movement of one or more body parts. For example, a user with limited finger usage functionality may use their toes, or other body parts, to tap on the rhythm training device.

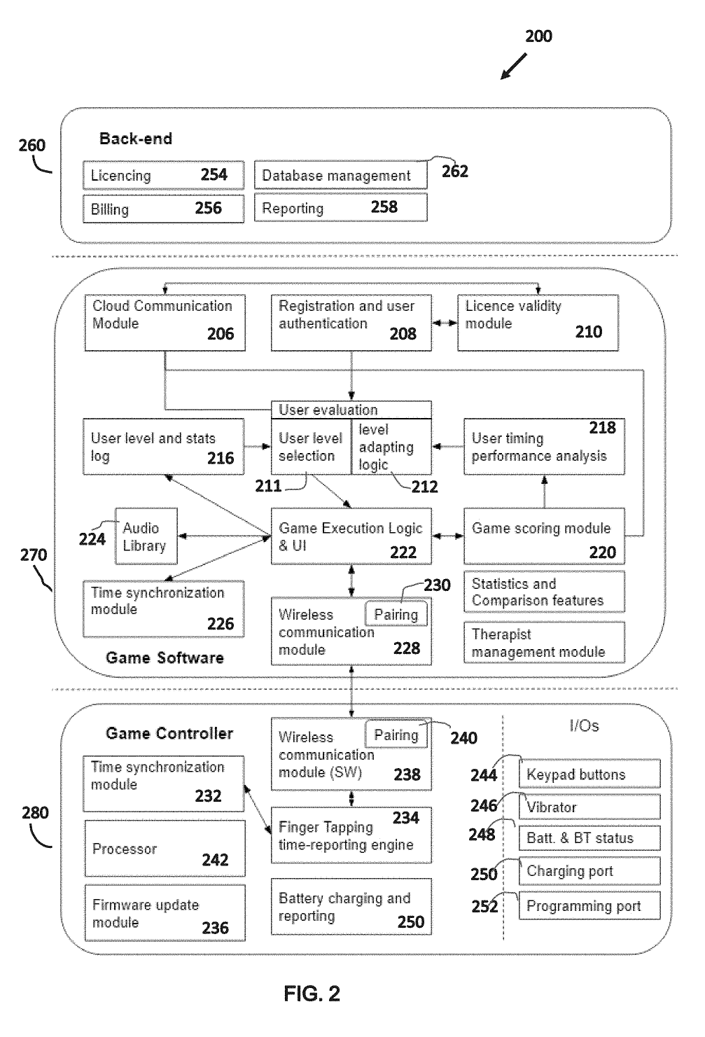

Reference is now made to FIG. 2, which is a schematic system diagram of an interactive game platform or system 200, depicting a configuration of the gaming software 270 elements of software sub-system 115, adapted to operate with computer device 110, the game controller elements 280, adapted to operate with the Rhythm-training device, and the Back end 260 elements, for facilitating advanced features, for example, licensing 254, billing 256, reporting 258 and database management 262 elements relating to the mental performance enhancement system or platform herein described, according to some embodiments.

As can be seen, gaming software 270 elements of software sub-system 115 are adapted to operate with computer device 110, and are also adapted to operate with the software and hardware elements related to rhythm-training device 280, for facilitating mental performance enhancement using games or challenges, according to some embodiments. One or more Gaining software 270 elements generally communicate and/or make use of computer device 110 elements. For example, the gaming software may rely on the computer device timer, rhythm or audio signal generator, graphics controller, audio player, processor, storage memory, RAM, etc. Further, computer device audio files, in some cases even metronome functionality, may be provided. The computer device database of rhythmic music or other media files may be used by the gaming software execution file. In some cases, different audio files may be used to provide games at different levels of challenge, for example, using amplified rhythms or varying rhythms. In some cases, higher challenge levels may get the user bonuses or extra points. In some cases, audio rhythms or files that are used in the games or simulations provided may include audio signals such as beats, melodies, audio tracks, missing beats, alternating or changing audio signal patterns, alternating or changing audio signal rates, alternating or changing audio signal power levels, and alternating or changing audio signal types etc.

As can be seen in the figure, software elements 270 may include a cloud communication module 206, to communicate, optionally in real time, with the communications cloud. Further software elements may include: A registration and user authentication module 208; license validity module 210, a game execution engine and User Interface (UI) code 222, connected to game scoring module 220, audio library 224, for maintaining a library of game audio files and other audio related elements. UI code may enable visual and audio content to be delivered to a user on the computer device, optionally via a browser, an application interface, a gaming interface or other user interface. Time synchronization modules 226 and 232 are also provided, which synchronizes the audio and visual cues produced by the game execution module 222 in computing device 110 with the tapping time-reporting engine 234 of the keypad device 280. This synchronization is critical to enable ˜1-2 millisecond accuracy in timing or tracking of user performance, for example button tapping, on rhythm training device 280. Further, a wireless communications module 228 is provided, including a communications pairing capability 230. The software further includes a user level selection feature 211, closely connected to a level adapting logic 212. Level adapting logic 212 may be used to control game or challenge levels in accordance with the user past performance or initial evaluation test, and in general is in communication with a user level and stats log 216, as well as with a user timing performance analysis module 218, that also relates to data measured by game scoring module 220.

As can be further seen in the figure, hardware and software elements related to the rhythm-training device 280 may include a wireless communications module 238, including a communications pairing capability 240, to enable fast and reliable communication between rhythm-training device 280 and game software 270. Device 280 further includes a communications chip, for example Bluetooth (BLE) communications chip, or other suitable communications chip(s). In one example, the BLE chip may run a synchronization algorithm to the game software on the computer device, to help clock synchronizing between the devices. Rhythm-training device 280 also includes a time synchronization module 232, which critically works with time synchronization module 226 to ensure time synchronization between rhythm-training device 280 and game software 270 for accurate measurement and performance of games or sessions. Time synchronization modules 226 and 232 connect to each other to allow the rhythm-training device to sync with the computing device, when the units are paired, to allow a high level of time synchronization. In general, each new game requires a new sync of time between the rhythm-training device and computing device software, to be able to enable the keypad taps to be accurately recorded, measured and utilized for optimal game playing.

Rhythm-training device 280 also includes a tapping time reporting engine 234, relating to the user actions on keypad buttons 244, which includes code to process and report time-stamp data to send to the computer device. For example, reporting engine 234 or other system elements may time-stamp each key stroke or tap made on rhythm training device 280. Reporting engine 234 may report all changes of state of the key buttons. Typically, keypad buttons are individual mechanical switches, providing greater speed and accuracy in measuring key taps, which are important to enable measurement of close to exact user timing performance. For example, keys can generally be measured according to approximately 1 millisecond response time, or in other applications, between 0.1 ms-500 ms. In sonic embodiments rhythm-training device also includes anti-bouncing processing on the rhythm-training device, to enable one tap identification of key hits or taps. In some cases, keypad buttons 244 may include 12 keys configured ergonomically and/or functionally for the respective left and right hand fingers, and additional training keys, such as up/down keys. This embodiment can enable usage of a single, some or all fingers of one or both hands potentially, and having infinite potential finger tapping patterns and combinations. Of course, different numbers, configurations and types of keypads may be used, as required.

In sonic embodiments tapping device 280 may be a keyboard or touch screen device, for allowing quick user responses to be measured and tracked. In still further embodiments, tapping device 280 may be an external device or an internal device integrated into a computing device.

In some embodiments, the different fingers may be identified to track which fingers do the tapping or clicking. In other examples the different hands may be identified to track which hands do the tapping or clicking. Such tracking can be used to enhance challenges, track progress, and in general, to help improve performance. In still further embodiments, the timing of finger release may be tracked, in place of or in addition to the timing of the finger tapping, to enable provision of additional challenges.

In some embodiments, standard deviation of taps may be checked, for example, to help identify a consistent delay in user tapping. In this example, if the user performs multiple continuous taps with a meaningful time delay but with a low standard deviation, this may indicate concentration or attention abilities that are meaningful and positive.

Rhythm-training device 280 may include a processor 242; battery charging and reporting module 250; and firmware update module 236. In some cases, the rhythm-training device may have a non chargeable battery, or alternative power source. In general, firmware on the device, for example for handling timing and synchronization, may be pre-installed and/or updatable. Rhythm-training device 280 may include a Battery and Battery status module 248, a charging port 250, and programming port 252. In some cases, a Vibrator element 246 may be integrated into the keypad device 280, optionally connected to tapping time reporting engine 234. For example, the vibrator may provide the user with an indication once they have tapped on a wrong key or outside the “time window” that the specific level allows for,

According to some embodiments, a mental enhancement performance game, such as an attention enhancement game, may challenge a user to perform responses using a personalized combination of Graphics and Audio cues from the computing device in communication with the rhythm-training device. For example, the Rhythm-training device (with identification+measurement+communication to the computing device using Bluetooth), may enable accurate measurements of user clicks, to record and use the performance results, and graphically display them in a selected way on a display connected to the computing device in some examples the user may use 1-10 fingers on the rhythm-training device. Further, various challenges may be given to a user, such as Fixed rhythm usage (from 120 BMP and lower), a variety of rhythm or beat speeds, usage of Multi finger combinations using stationary and/or dynamic tapping. Further, the challenges may be varied by type, genre, kind, aim, target age, level of challenge etc. In still further examples, left/right hands can be individually used, for example, to enhance performance with a selected hand, or the hands in combination.

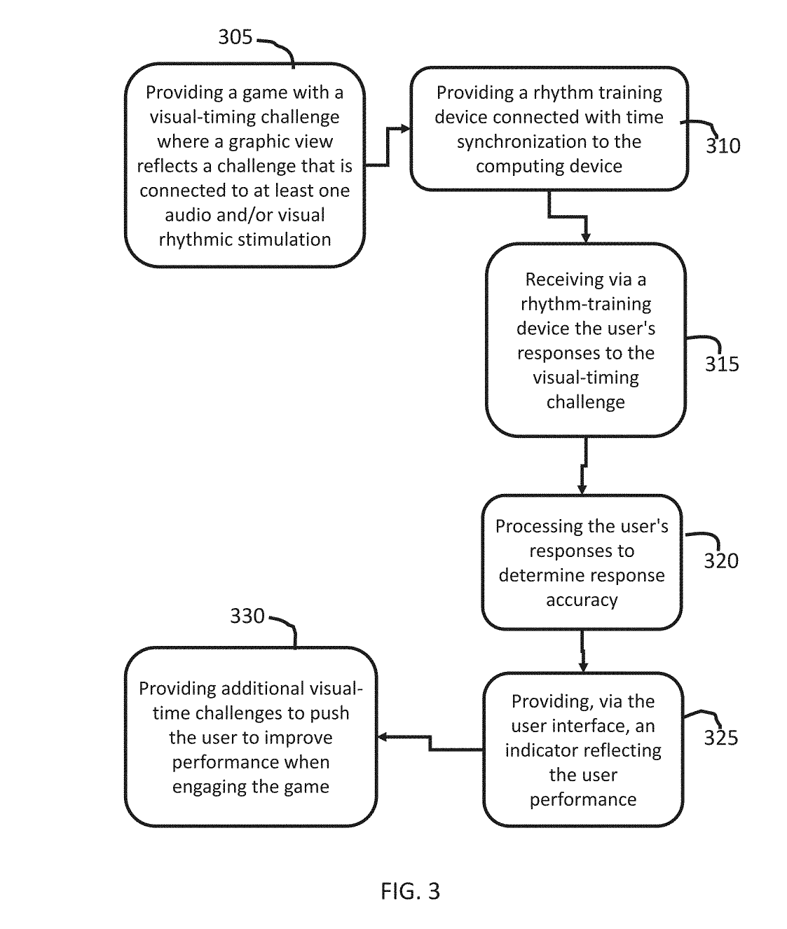

Reference is now made to FIG. 3, which shows a flow chart describing a high level process of delivering mental performance training using a rhythm training device, according to some embodiments. As can be seen, at step 305, a game with a visual-timing challenge can be provided by a computing device, where a graphic view reflects a challenge that may be connected to at least one audio rhythm stimulation and/or visual simulation or game, the audio rhythm typically functioning as a series of reference signals separated by selected time intervals. In some cases, a user may be pre-tested or diagnosed, using the current system or another system, in which case the initial user level can be set. At step 310, a rhythm training device connected with time synchronization to the computing device is provided. For example, a clock synchronization should be set up between the game or application and the rhythm training device. In some cases, the training device may have triggers, such as keys or buttons adaptive to receive user responses to reference signals. At step 315, the user's responses to the visual-timing challenges, or reference signals is received, via a rhythm-training device. For example, the user may use the multiple keys on the training device to tap in response to the audio and/or graphic signals. At step 320, the user's responses are processed, to determine response accuracy, based on a temporal relationship between the user response using the trigger(s) and the occurrence of the corresponding reference signal. At step 325, an indicator reflecting the user performance is provided, via the user interface, optionally in real time to reflect on a past or current cue. At step 330, additional visual-time challenges are provided to push the user to improve performance when engaging the game. For example, the user may be given more challenging levels, games, formats, challenge elements, to maintain and/or keep developing, the user skills development. In still further cases, if it is determined that the user is not improving their performance, or their performance is regressing, an alert may be send to the user and/or other system users. In such cases a new level check may be required, a new user program may be developed, or a different training program may be suggested. Of course, other cases or examples may be used, depending on the situation.

In some embodiments, the game or games provided to a user may be configured in accordance with a generic or personalized training program, according to a user type, user age, user gender, in accordance with the user's performance, etc.

In some embodiments, the rhythm training device may be connected to a communications cloud, to enable performance to be reported to the cloud, for example, to enable the user profile to be stored on and accessed via the Cloud.

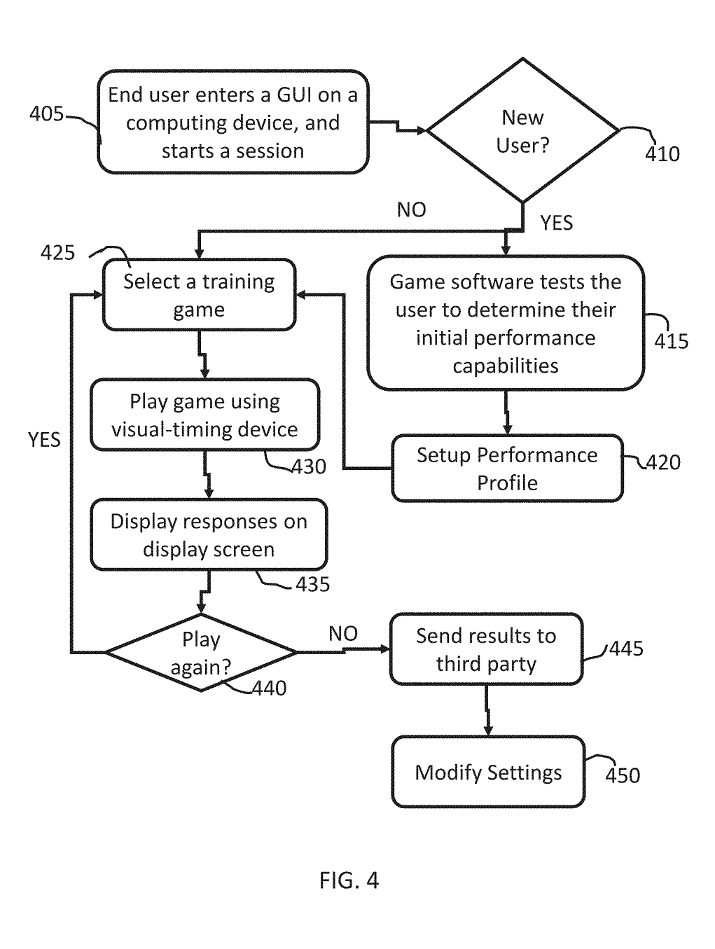

Reference is now made to FIG. 4, which shows a flow chart of an example of an implementation of a personalized cognitive enhancement game, according to some embodiments. As can be seen, at step 405, an end user can enter a GUI on a computing device, and start a session, using the configured visual-timing challenge game software. If it is a new user, at step 410 the game software may initially test the user to determine their initial performance capabilities, and optionally diagnose the user for various conditions. At step 415 an initial user performance profile can be set up. At step 420, if the user is an existing user with a performance profile, a training game can be selected, or at step 425, a training game can be automatically provided, based on previous user performance. At step 430 the user may start the game, whereafter at step 435, the user can play the game using the visual-timing device. At step 440 the user's responses to game clues or challenges is displayed on the display screen, in real time and/or following a play, optionally featuring individual results, groups of results, or the results for the entire game. At step 445, after the game finishes, the user may be offered to play another game. At step 450 the results may be send to a parent, therapist, organisation etc., to optionally monitor, track or study the results. Optionally, at step 455, the user, parent, therapist, organisation etc, may change settings, set up future preferences, configure a future game to be played etc., in accordance with the user's past or accumulated performance.

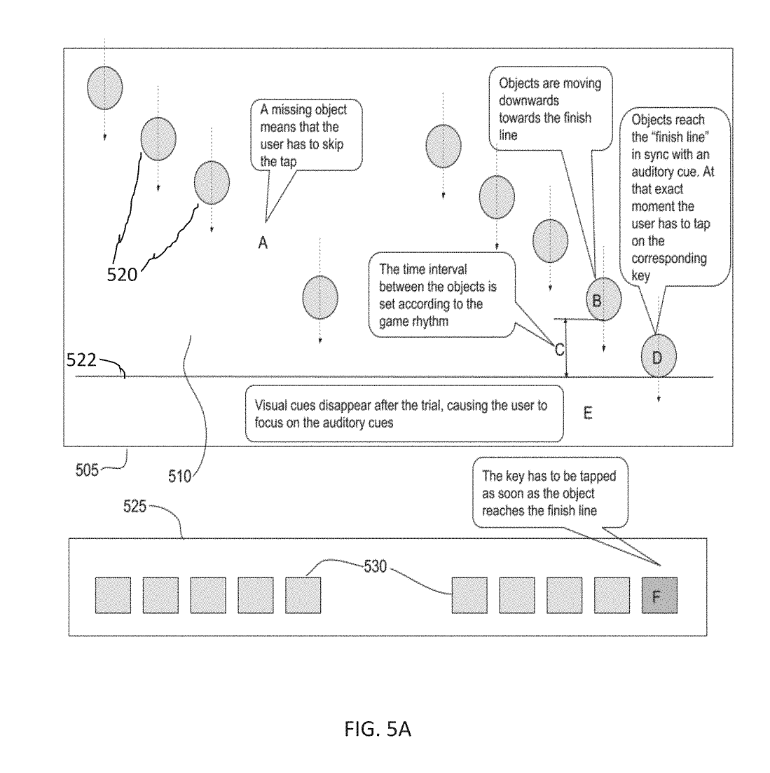

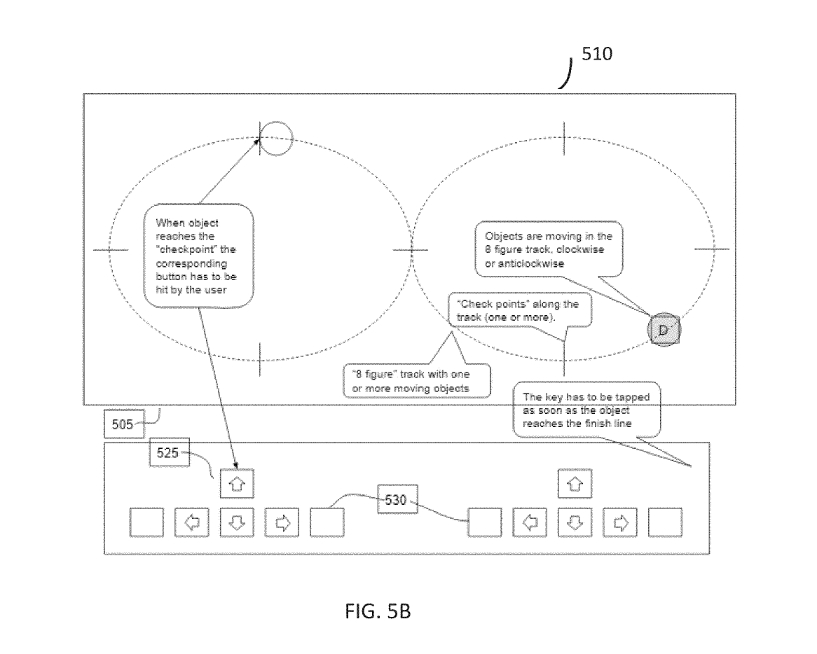

Reference is now made to FIG. 5A, which is a schematic graphic image of an example of a mental enhancement challenge game screen and keypad, according to some embodiments. As can be seen, a viewer or screen 505, connected to computing device or integrated into computing device 110, displays a GUI 510. GUI 510 in the figure shows one example of a mental challenge game, wherein objects 520 move down the screen, and the user is challenged to use one or more of the buttons 530 on Rhythm-training device 525, to engage or target the descending targets preferably just as they reach the “finish” line 522. Buttons 530 may include left or right hand buttons on the keypad device, wherein each hand may have up to five buttons for each finger. Different button numbers, positions or configurations may be used. As the user successfully performs button taps to engage the objects, points may be given to the user, and the number of points may relate to the level of accuracy, speed of tap etc. Typically, the graphics provided by the GUI may be accompanied by audio sounds, optionally rhythmically based sound beats. In some games the primary aim of the game is to encourage the user to perform button taps in relation to the audio signals provided. In further embodiments the visual cues might disappear after some time, to challenge the user to keep on tapping on the same or previous pattern by following the audio cues alone. In still other embodiments the user may be challenged to execute a tap within a specific “time window” which may vary according to the game level.

As can be further seen in the figure, many functions and challenges may be delivered through the games, to help train or teach user to develop their cognitive skills. For example, a missing object A may mean that the user must skip a tap. Object B, which is descending and getting close to the finish line, may challenge the user by becoming the agent of pressure to be ready to respond to its movement to handle it on time, after the previous object (D) has completed its descent. Position C may represent the time interval between the objects, set according to the game rhythm. Object D, which is an object that reaches the finish line, typically in sync with an auditory signal or clue, challenges the user to tap on the corresponding key at the precise time of contact. Key F represents an example of a key on the keypad, that corresponds in the current example to object D, that should be engaged as it touches the end line. Of course, the figure shows one example, and many different objects, buttons, GUI's, challenges, etc. may be used.

Reference is now made to FIG. 5B, which is a schematic graphic image of an example of a mental enhancement challenge game screen and keypad, according to some embodiments, wherein the routes for character movement may be infinity (8) shaped, such that one or more objects can move around the 8 shaped track. Of course, other shapes or route types may be used.

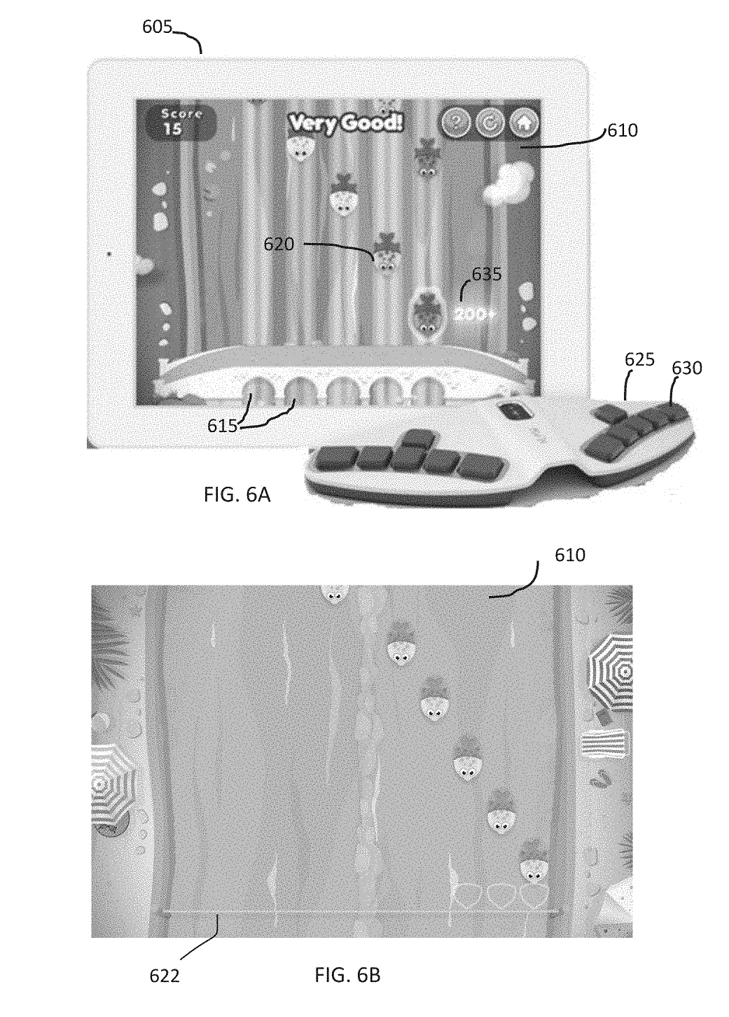

Reference is now made to FIG. 6A, which is a screenshot of an example of a mental enhancement challenge game screen, according to some embodiments. As can be seen, a viewer or screen 605, connected to computing device or integrated into computing device 110, displays a GUI 610. GUI 610 in the figure shows one example of a mental challenge game, wherein fish 620 swim downstream, or down-screen, and the user is challenged to use one or more of the buttons 630 on keypad device 625, to engage or target the descending fish. Buttons 630 may represent shooter elements 615 on the screen—in the current example only 5 shooting elements 615 are presented, representing left or right hand buttons on the keypad device. As the user successfully performs button taps to engage fish, points 635 may be given, and the number of points may relate to the level of accuracy, speed of tap etc. Typically, the graphics provided by the GUI may be accompanied by audio sounds, optionally rhythmically based sounds. In some games the game may be used to encourage the user to perform button taps in relation to the audio signals or visual cues provided.

Reference is now made to FIG. 6B, which is a screenshot of a further example of a mental enhancement challenge game screen, according to some embodiments, where an alternative version of finish line 622 is shown. Of course, various patters, routes and pathways may be used.

According to some embodiments, performance comparison functionality may be provided, for example, using Level adapting logic, for helping users learn, adjust performance, and share their performance levels with other users or observers. In one example, a system of handicaps may be used, to allow users to play against other users on different performance levels.

According to some embodiments, game based motor training feedback and challenges may be provided via the communications cloud, to enable cloud based gaming competition between connected users.

According to some embodiments, music on the computing device may be used for and/or integrated into the games or challenges provided. For example, music or audio files on the computing device or on the communications cloud may be categorized by BPM or other attributes, and may be integrated into games according to their categorization(s). In still further embodiments, music or audio files on the computing device or on the communications cloud may be converted into a rhythm-training device usable music or audio format.

According to some embodiments, the rhythm-training device may include a module to enable multi-user support, for example, to enable a therapist or institute to use a single device with multiple users, and to maintain separate user profiles for the different users.

According to some embodiments, the rhythm-training device may include a License validity management module, typically in communication with the communications cloud. Such a module may enable, for example, sessions or games to be tracked and enabled for usage in accordance with payments made, subscription models etc.

In some embodiments, extended game based training programs may be provided, for example, to provide a 15 minutes a day program for 4-8 weeks, with the challenges increasing in difficulty as the program advances. In a further example, the program may include 1 day on 1 day off, for ˜20 minutes, and for ˜20 sessions. In a further example of a program, a program may last for 2-4 months, or less or more, to give the user time to learn, execute, improve performance, and internalize teachings. Of course, other programs, whether shorter or longer, more or less intense, may be used.

In still further embodiments, the computer device may provide incentives, for example bonuses, for good performance, improved performance etc., for example, based on tapping speed, accuracy, consistency etc. The Game engine and UI 222 may further provide statistics, reports, charts etc., to show performance tracking progress.

According to some embodiments, games may be varied, for example, being based on one or different games, on fixed time tapping, dynamic time tapping, metronome based cues, music based on a beat, audio that can fade in/out; games that incorporate auditory and/or visual distractions, audio files that use missing beats etc. In one example, a user is required to various finger tapping patterns for the different levels. In a further example, a game element may require that at advanced levels the user may have to respond in a narrower time window. In further examples other game variables may be used, such as changes in BPM, the music elements, including missing beats in the rhythm, level length, auditory and visual distractions, use of different fingers and different tapping patterns for different fingers, tapping on keys as well as holding keys down for a period, etc.

In still further embodiments, visual simulations or challenges may be used, in addition to repeated rhythmic auditory cues, to teach a user a pattern, and subsequently the visual support may be reduced, limited or removed entirely, to encourage or push the user to focus on the auditory rhythm signal.

In yet further embodiments, a user's over tapping and/or missed taps etc. may be tracked. In some cases, a special formula may be used to provide a score that represents the user's motor timing performance based on these variables or metrics.

In general, embodiments may be provided that enable adaptive game training, by learning the users' performance level and providing challenges according to the selected users' level or challenges.

According to certain embodiments, a training game can be played with stereo headphones, according so some embodiments. In some cases, challenge levels may be provided that can be delivered to one ear, or selected ears. For example, a cue may be delivered to the left ear with an instruction to respond with the right hand, and vice versa. In other example, different music variations may be used in different ears. For example, a fixed beat of 60-90 BPM can be used in a training game, and then various music elements may be entered that will impact on the beat sound, thereby fixed and/or dynamic beats can be used, and optionally in combination. Further, other elements of music or audio based cues may be integrated, such as rhythm, meter, arsis, thesis, frequency of the music's pulse, tempo, Diapason, Volume, instruments, Color, and Overtones can be used, optionally in combination. In this way, the music variations can be included in parts of the game levels. In one example, every 4th beat in higher volume or in other instruments, such that the user will be challenged to do a different tapping on that beat. The user may need to memorize these patterns to execute it successfully, optionally in combinations between the 2 ear if using stereo earphones.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A sensory motor method for training a mental skill comprising:
configuring a rhythm based training application on a user computing device; providing via the training application a game with a visual-timing challenge where a graphic view reflects a challenge that is connected to at least one audio rhythm;
configuring a rhythm training device with one or more mechanical keys, in communication with the user computing device;
receiving via a rhythm-training device a user's mechanical responses to the visual-timing challenge;
processing the user's mechanical responses to determine response accuracy; and
providing, via the user interface, an indicator reflecting the user's performance.

2. The method of claim 1, further comprising providing additional visual-time challenges to push the user to improve performance when engaging the game, the additional challenges to be configured in accordance with the user's performance level.

3. The method of claim 1, wherein the mechanical responses may be selected from the group consisting of single finger taps, multiple-finger taps, and movement of one or more body parts.

4. The method of claim 1, wherein the audio rhythm may be selected from the group consisting of beats, melodies, audio tracks, missing beats, alternating or changing audio signal patterns, alternating or changing audio signal rates, alternating or changing audio signal power levels, and alternating or changing audio signal types.

5. The method of claim 2, further comprising providing additional visual-time challenges to push the user to improve performance when engaging the game, the additional challenges to be configured in accordance with a training program.

6. The method of claim 3, wherein the training program is personalized for a user type.

7. The method of claim 3, wherein the training program is personalized for a specific user.

8. A rhythm-training platform, comprising:
a user computing device configured to run an application configured to provide graphic and rhythm based cues to challenge a user to respond to the cues; and
a user rhythm-training device connectable to the user computer device, the rhythm-training device having input elements capable to enable highly accurate measurement of the user's responses to the cues on the input elements,
wherein the computing device processes the user responses,
and wherein the application provides an indication of the user's response performance.

9. The platform of claim 8, wherein the input elements may be selected from the group consisting of one or more mechanical keys, one or more touch response elements, one or more mechanical buttons, and one or more mechanical switches.

10. The platform of claim 8, wherein the user responses may be selected from the group consisting of single finger taps, multiple-finger taps, and movement of one or more body parts.

11. The platform of claim 8, wherein the rhythm based cues may be selected from the group consisting of beats, melodies, audio tracks, missing beats, alternating or changing audio signal patterns, alternating or changing audio signal rates, alternating or changing audio signal power levels, and alternating or changing audio signal types.

12. The platform of claim 8, wherein the user computing device includes user level adapting code for controlling rhythm based audio challenges given to a user, to be personalized in accordance with the user's performance.

13. The platform of claim 8, further comprising a communications cloud with an associated game server, for processing user performance in the cloud, for multiple users, to provide one or more services including storage of data, retrieving updates, billing, licensing, user cooperating, synchronizing with other computer devices, and synchronizing with other rhythm-training devices connected to the communications cloud.

14. A machine readable medium containing instructions that, when executed by a computing device, cause the computing device to perform a mental performance training method, the method comprising:
providing graphic and rhythm based reference cues to challenge a user to respond to the cues, by the computing device;
recording user responses to the cues, as entered by the user on a rhythm-training device connected to the computing device, wherein the rhythm-training device has one or more input keys adapted to enable highly accurate measurement of the user's responses to the cues;
processing the user responses to determine progress of user performance in response to challenges; and
delivering to one or more machine readable medium users feedback on the progress of one or more users.

15. The machine readable medium of claim 14, further comprising delivering additional challenges configured in accordance with one or more of the user's performance level, the user type, a generic training program, and a personalized training program.
